(19) United States
(12) Patent Application Publication
(10) Pub. No.: US 2026/0113305 A1
(43) Pub. Date: Apr. 23, 2026

(54) PRIVATE NETWORK ACCESS TO EXTERNAL APPLICATIONS VIA PROXY NODES

(71) Applicant: Tailscale Inc., Toronto (CA)

(72) Inventors: Charlotte Brandhorst-Satzkorn, Squamish (CA); James Tucker, Redwood City, CA (US); Thomas Michael Trevor D'Netto, San Francisco, CA (US); Maisem J. Ali, Woodinville, WA (US)

(21) Appl. No.: 19/280,706

(22) Filed: Jul. 25, 2025

Related U.S. Application Data
(60) Provisional application No. 63/709,310, filed on Oct. 18, 2024.

(51) Int. Cl. H04L 9/40; H04L 61/4511

(52) U.S. Cl. CPC H04L 63/0281; H04L 61/4511; H04L 63/101

(57) ABSTRACT

The technology disclosed herein enables access to an external application by a node within a private network via a proxy node of the private network. In a particular example, a method includes determining an external domain in which an application is located. The external domain is external to an internal domain for the private network. The method further includes selecting a proxy node in the internal domain to be a proxy for communications exchanged with the application and advertising, from the proxy node to nodes in the private network, an external-domain route to the external domain. The method also includes routing traffic exchanged between the private network and the application via the external-domain route through the proxy node.

### RELATED APPLICATIONS

This application is related to and claims priority to U.S. Provisional Patent Application 63/709,310, titled “PRIVATE NETWORK ACCESS TO EXTERNAL APPLICATIONS VIA PROXY NODES,” filed October 18, 2024, and which is hereby incorporated by reference in its entirety.

### BACKGROUND

Virtual Private Networks (VPNs) work by creating a logical network overlay that allows devices to communicate securely over underlying networks, such as a public or untrusted network (e.g., the Internet). The overlay is achieved through a process called encapsulation, where the data packets sent between devices are wrapped inside additional packets that include encrypted information. For instance, when a VPN endpoint device sends data through a VPN, a packet carrying the data is encrypted and then encapsulated with a new packet header that includes a public IP address of another VPN endpoint device as the destination. This encapsulated packet is then sent over a public network to the destination VPN endpoint device.

At the destination VPN endpoint device, the outer packet header is stripped away to reveal the original encrypted packet. The original packet is then decrypted, allowing the data to be processed by the device. In some examples, the VPN endpoint device may be a VPN server operating as a gateway to the public network. In those examples, the decrypted original packet may be transmitted to a destination IP address on the public network identified in a header of the original packet. The above encryption method ensures that the data remains confidential and secure as it travels over potentially insecure networks, as only the VPN destination endpoint can decrypt and access the original information. By creating a secure tunnel through encryption and encapsulation, VPNs effectively simulate a private network over a public infrastructure, providing privacy and security for users.

VPN endpoints may also connect with systems external to the VPN. Communications with the external systems are not encapsulated like those between endpoints of the VPN because the external systems will not be able to decrypt the encapsulated packets. Those external communications, therefore, may not be subject to controls implemented by the VPN. Those controls may include permissions to access external applications associated with the VPN (e.g., an entity operating the VPN may subscribe to an application for use by endpoints on the VPN). An external application would typically require information indicating that an endpoint is associated with the VPN prior to enabling the endpoint to access the application.

### SUMMARY

The technology disclosed herein enables access to an external application by a node within a private network via a proxy node of the private network. In a particular example, a method includes determining an external domain in which an application is located. The external domain is external to an internal domain for the private network. The method further includes selecting a proxy node in the internal domain to be a proxy for communications exchanged with the application and advertising, from the proxy node to nodes in the private network, an external-domain route to the external domain. The method also includes routing traffic exchanged between the private network and the application via the external-domain route through the proxy node.

In another example, an apparatus implements the proxy node. The apparatus includes one or more computer readable storage media, and one or more processing systems operatively coupled with the one or more computer readable storage media. Program instructions stored on the one or more computer readable storage media, when read and executed by the processing system, direct the apparatus to receive, from a control plane of the private network, an indication of an external domain in which an application is located. The external domain is external to an internal domain for the private network and the control plane selects the node to be a proxy in the internal domain for communications exchanged with the application. The program instructions further direct the apparatus to advertise, to the nodes in the private network, an external-domain route to the external domain and route traffic exchanged between the nodes in the private network and the application in accordance with the external-domain route

In a further example, system forms a private network. The system includes a control plane of the private network configured to determine an external domain in which an application is located. The external domain is external to an internal domain for the private network. The control plane is also configured to select a proxy node in the internal domain to be a proxy for communications exchanged with the application. The system also includes the proxy node configured to advertise within the internal domain an external-domain route to the external domain, receive, from other nodes in the internal domain, traffic directed to the external domain, and send the traffic to the external-domain route.

### BRIEF DESCRIPTION OF THE DRAWINGS

FIG. 1 illustrates an implementation for controlling access to external applications from within a private network.

FIG. 2 illustrates an operation to control access to external applications from within a private network.

FIG. 3 illustrates an implementation for controlling access to external applications from within a private network.

FIG. 4 illustrates an operational scenario for controlling access to external applications from within a private network.

FIG. 5 illustrates an operation to control access to external applications from within a private network.

FIG. 6 illustrates an operation to control access to external applications from within a private network.

FIG. 7 illustrates an operation to control access to external applications from within a private network.

FIG. 8 illustrates a computing system for controlling access to external applications from within a private network.

### DETAILED DESCRIPTION

A network address domain is a logical grouping of network addresses that allows for the organization and management of devices within a network. It typically consists of a collection of Internet Protocol (IP) addresses that share a common prefix, enabling efficient routing, resource allocation, and security policies. Domains can span across local networks or the Internet, and also help facilitate/control communication among devices by defining boundaries for network services, access controls, and administrative oversight.

A domain of a VPN (or other logical overlay network), referred to herein as an internal domain, is the private network space created for users connected to the VPN. The internal domain provides secure access to resources, data, and services that are restricted to authenticated users (e.g., via the users’ endpoints) within the VPN. This internal domain typically employs unique IP addressing schemes and security protocols to isolate and protect communications from external threats. In contrast, an external domain encompasses the broader Internet or external networks outside the VPN, where traffic is less controlled and more susceptible to potential vulnerabilities.

While it may be preferable for node (e.g., VPN tunnel endpoint) to only communicate with other nodes in the internal domain, certain services may be provided from systems outside of the domain. Thus, a mechanism for controlling access to these external services would be beneficial to nodes in the internal domain. The proxy nodes described below provide just such a mechanism. A proxy node facilitates secure and direct connectivity between applications providing services across different networks (e.g., between the internal domain and a domain external to the internal domain). These proxy nodes allow users to create secure, authenticated access points for applications hosted on various devices, enabling seamless communication without requiring complex network configurations or exposing services to the public internet. Identity-based access controls for the logical network ensure only authorized users and devices can access specific applications external to the internal domain. This enhances security while simplifying the process of connecting applications to nodes within the internal domain.

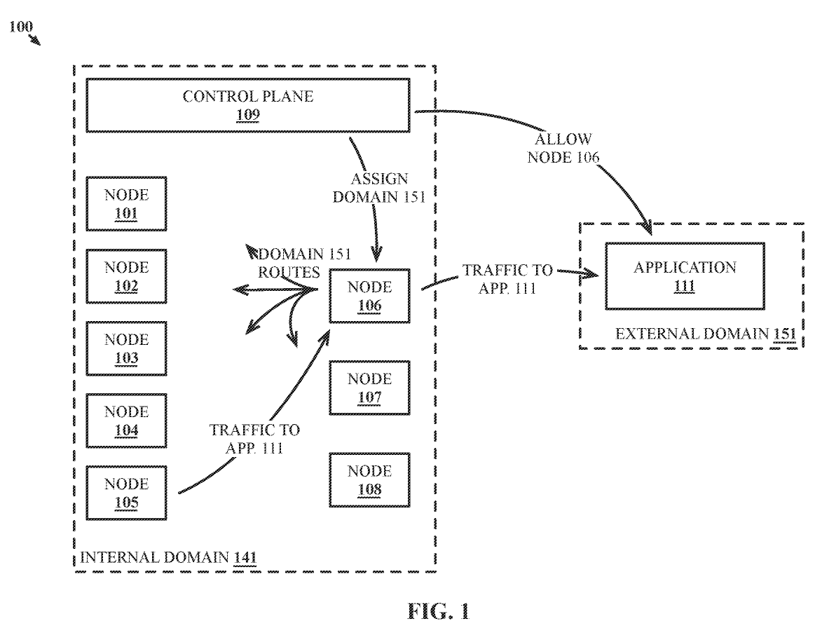

FIG. 1 illustrates implementation 100 for controlling access to external applications from within a private network. Implementation 100 includes nodes 101-108 in internal domain 141 and application 111 in external domain 151. The logical network formed between nodes 101-108 using internal domain 141 is controlled by control plane 109. Control plane 109 may be executing on a dedicated computing system in internal domain 141 (e.g., may be one of nodes 101-108), may execute on one of nodes 101-108, may be distributed across at least a portion of nodes 101-108, or may execute in some other manner.

The logical network using internal domain 141 is a private network, such as a VPN, that uses an authentication mechanism to ensure computing devices connected to the logical network, such as nodes 101-108, are authorized to join the logical network. The logical network is an overlay network on physical networking hardware, such wired/wireless communication links, routers, switches, firewalls, computing devices, or other type of components for providing network communications between computing systems. In some examples, at least a portion of the physical networking hardware is included in, or underlies a portion of, an external network having external domain 151. The underlying physical hardware may include one or more local area networks, wide area networks (e.g., the Internet), or some other type of network. Application 111 provides a computing service from within external domain 151. Application 111 may provide data processing, data storage, media server, or some other type of resource that may be accessible over a network. Application 111 may execute on one or more computing systems, such as servers, to provide the computing service.

Control plane 109 manages connections and interactions between nodes 101-108. Control plane 109 facilitates the initial authentication and ongoing management of nodes 101-108. When a device attempts to join internal domain 141, the device communicates with control plane 109 to verify the device’s identity, handle key exchanges, and assign network addresses in internal domain 141. Control plane 109, therefore, ensures only authorized devices can connect and interact with each other within internal domain 141 by maintaining an up-to-date directory of valid nodes and their associated credentials.

Beyond authentication, control plane 109 may also help with routing and maintaining connectivity between nodes 101-108. Control plane 109 may track the current network topology and support the dynamic updating of device information, such as IP addresses and connection states. This ensures that devices can efficiently discover and communicate with each other, even as they move between different underlying networks or change their connection statuses. By centralizing these functions, control plane 109 simplifies network management and enhances the overall security and reliability.

In this example, control plane 109 also selects a proxy node for exchanging communications between nodes 101-108 and application 111. The selected proxy node handles DNS requests for external domain 151. This enables the proxy node to determine a route to application 111 in external domain 151 and advertise that route in internal domain 141. Thus, should any other of nodes 101-108 want to communicate with external domain 151, the other nodes will route the communications via the proxy node rather than some other route.

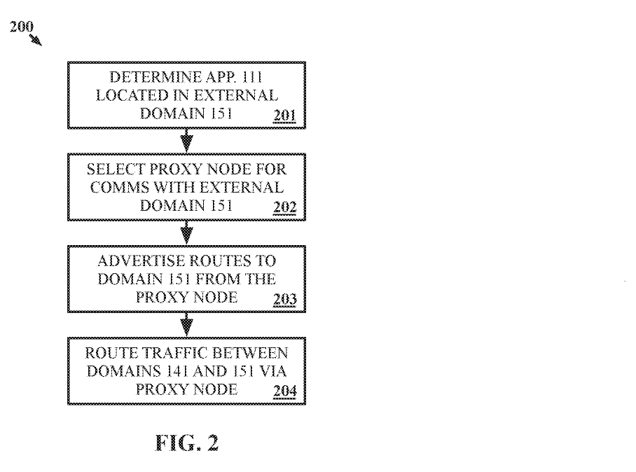

FIG. 2 illustrates operation 200 to control access to external applications from within a private network. In this example, control plane 109 determines an external domain in which application 111 is located (step 201). A user, such as an administrator of internal domain 141, may identify the domain to control plane 109. Alternatively, control plane 109 may receive an identifier for application 111 (e.g., Application X) and control plane 109 may determine a domain identifier on its own (e.g., query another system for a domain of application 111). In one example, external domain 151 may be identified by a domain name (e.g., Uniform Resource Locator), network address (e.g., IP address), a subnet, or some other type of identifier.

Control plane 109 selects node 106 of nodes 101-108 to be the proxy node in internal domain 141 to be a proxy for communications exchanged with application 111 (step 202). Node 106 may be selected at random or arbitrarily from nodes 101-108, may be selected from a subset of nodes 101-108 capable of acting as a proxy (e.g., nodes 106-108 may be nodes capable of being a proxy and node 106 may be selected therefrom), may be selected as part of a load balancing scheme to distribute proxy responsibilities for different applications across different nodes, or may be selecting using some other selection logic. Control plane 109 notifies node 106 that node 106 is the selected proxy node for application 111. After being notified of its selection, node 106 determines a route to external domain 151. Node 106 may perform a Domain Name System (DNS) lookup on a domain name of application 111 to identify external domain 151 and a route thereto.

Node 106 advertises a route to external domain 151 to other nodes of nodes 101-108 in internal domain 141 (step 203). Advertising the route indicates to the other nodes that node 106 is where communication traffic (e.g., packets) should be sent to reach external domain 151 and application 111 therein. Since node 106 is the selected proxy node, node 106 is the only node within internal domain 141 advertising a route to external domain 151. This ensures node 106 is the node routing traffic exchanged between nodes in the private network and external domain 151 (step 204). For example, when node 105 intends to send packets to application 111 in external domain 151, the node identifies a route to external domain 151. Since node 106 advertises a route to external domain 151, node 105 sends the packets to node 106 as a next hop from node 105 on the route to external domain 151. Given that no other node is advertising a route to external domain 151, node 105 is unaware of a route to external domain 151 other than a route that goes through node 106, which effectively forces the use of node 106 as a proxy node.

With all communication traffic between internal domain 141 and application 111 passing through node 106, node 106 can be used to enforce permissions for accessing application 111, handle authentication for access to application 111, or perform some other type of access control on application 111. Node 106 may implicitly or explicitly regulate access to application 111. For example, if application 111 is meant to be accessible to any node in internal domain 141, node 106 may automatically route communications received via internal domain 141 under the assumption that a node authorized to communicate in internal domain 141 is also authorized to access application 111. In that example, control plane 109 may handle authentication for nodes to access the logical network of internal domain 141. The authentication process may involve exchanging cryptographic keys to establish trust between devices, ensuring that each node can securely identify and communicate with others within the network. For instance, when control plane 109 is provided with proper credentials (e.g., a username and password for a user operating a node) by a device, the device may generate and store its own private cryptographic key and provide only the corresponding public key to control plane 109. This ensures that the control plane only ever sees public components of the keys, minimizing the chance of any other node or system ever knowing the private keys. In some examples, private keys may be generated and stored within secure enclaves that provide a hardware-based security boundary, further preventing the private portions from being exposed to any other party. Control plane 109 may provide the device with network configuration information and public key material from other nodes to enable secure communication. Likewise, control plane 109 may provide network addresses of the other nodes. Those network addresses may include addresses within internal domain 141 and addresses in the underlying network(s) to which encapsulated packets can be sent. Regardless of the authentication process used, the authentication process enables communications over internal domain 141 to be secure enough such that node 106 does not require additional authentication to allow communications to be exchanged with application 111.

The authentication process may also be beneficial to control access to application 111 between users of internal domain 141. Since a node’s user may identify themselves when authenticating the node, node 106 may limit which users are allowed to access application 111. For example, control plane 109 may indicate to node 106 specific users that are allowed to access application 111. Control plane 109 may indicate the nodes associated with the users or may indicate the users while relying on logic in node 106 to identify which nodes are associated with which users. In an example of the latter, node 106 may maintain information locally indicating which nodes are associated with which users. Node 106 may receive such information whenever control plane 109 notifies node 106 that a new node has joined the logical network and provides information (e.g., network addresses and encryption keys) for communicating with the new node. Regardless of the mechanism used to identify nodes allowed access to application 111, node 106 can regulate which nodes can access application 111. Different regulation mechanisms may be used. For instance, node 106 may block traffic directed to application 111 from a node of a user not allowed to access application 111. Alternatively, node 106 may only advertise the route for external domain 151 to nodes of nodes 101-108 that are allowed to access application 111 or may prevent nodes not allowed to access application 111 from obtaining the external domain route (e.g., blocks or does not respond to DNS requests from the nodes).

There may be a number of different routes to external domain 151 advertised by node 106. In some examples, a user may provide user input explicitly indicating a route to external domain 151. One or more of the routes being advertised by node 106 may be sub-routes of the route indicated by the user. In those cases, node 106 may stop advertising the sub-routes and simply advertise the route indicated by the user instead because continuing to advertise the sub-routes would be redundant.

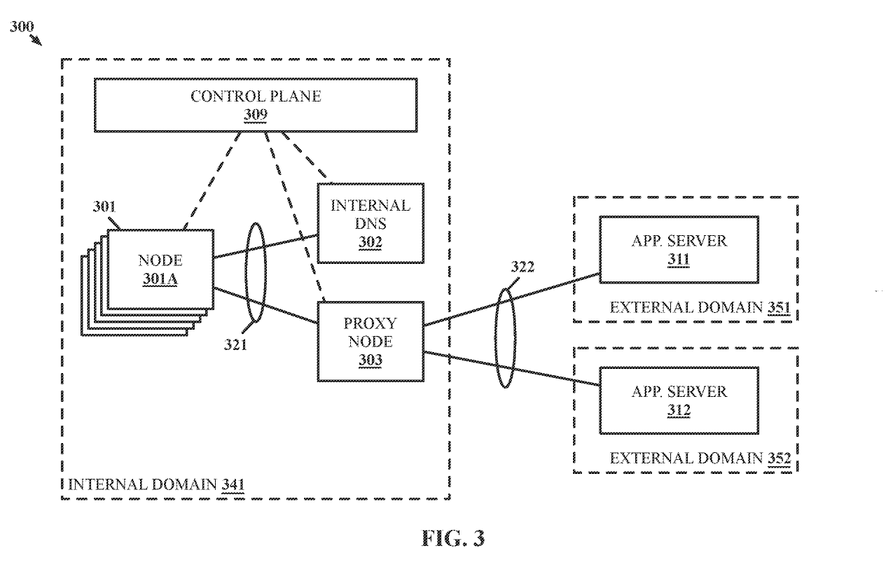

FIG. 3 illustrates implementation 300 for controlling access to external applications from within a private network. Implementation 300 includes nodes 301, internal DNS 302, proxy node 303, and control plane 309 within internal domain 341. Implementation 300 further includes application server 311 in external domain 351 and application server 312 in external domain 352. While shown separately from nodes 301, internal DNS 302 and proxy node 303 are also nodes of a logical network using internal domain 341. Control plane 309 may be implemented on a node of internal domain 341, may be distributed across nodes of internal domain 341, or may be implemented in some other manner.

In operation, application server 311 provides an application to at least one node of nodes 301 and application server 312 provides a different application to at least one node of nodes 301. Proxy node 303 is selected to be a proxy node for traffic exchanged with external domain 351 and external domain 352. In other examples, different nodes of internal domain 341 may be selected for each external domain. While only one server per application is shown, multiple application servers may be included in external domains 351-352 to handle additional load on the applications. Since proxy node 303 is selected to handle traffic for external domains 351-352 rather than application servers 311-312 individually, proxy node 303 will also handle traffic exchanged with other application servers that exist in external domains 351-352.

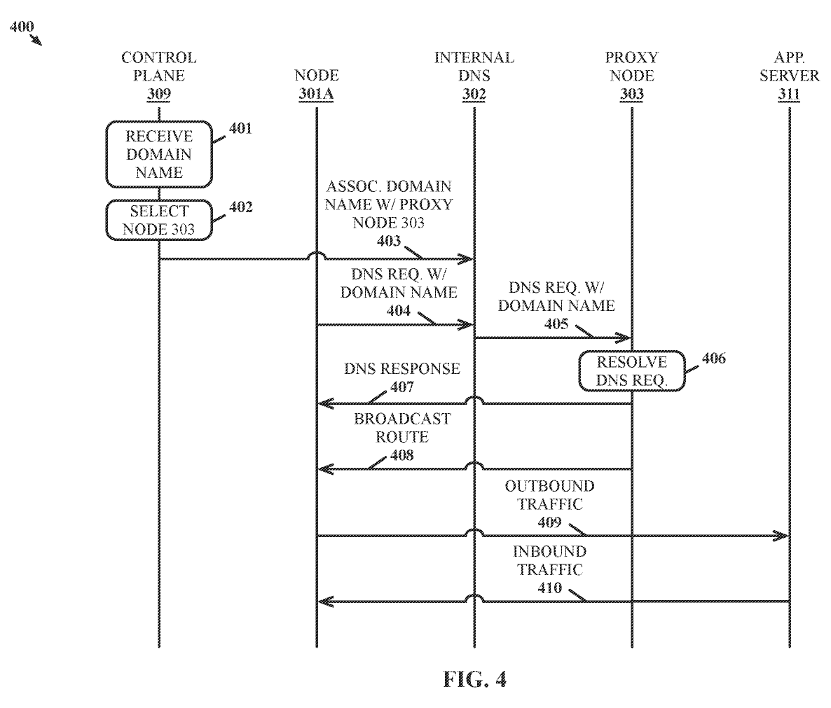

FIG. 4 illustrates operational scenario 400 for controlling access to external applications from within a private network. In operational scenario 400, control plane 309 receives a domain name corresponding to an application provided by application server 311 (step 401). For example, the domain name may be indicated in a URL (e.g., www.application311.com). A user may provide the domain name to control plane 309 and may also indicate which users in internal domain 341 are allowed to access the application. The user further instructs control plane 309 to use a proxy node to handle traffic exchanged with respect to the application (e.g., traffic exchanged with application server 311 or another server serving the application). In some cases, the user may specify which node should be used as a proxy but, in this example, control plane 309 selects proxy node 303 (step 402). Proxy node 303 may be selected because proxy node 303 is a node of a device type (or multiple device types) that is capable of operating as a proxy, proxy node 303 may be a node that is designated by a user as being capable of operating as a proxy, or proxy node 303 may be selected using some other logic. In an example, the operator of internal domain 341 may attach dedicated servers for proxy use to the logical network of internal domain 341. Proxy node 303 may be one of those servers. This ensures a less capable system, such as a user’s personal computer not configured to handle large amounts of application traffic, is not selected to act as a proxy for nodes of internal domain 341.

After selecting proxy node 303, control plane 309 notifies internal DNS 302 that the domain name should be associated with proxy node 303 (step 403). Internal DNS 302 operates within the logical network of internal domain 341 to resolve domain names to IP addresses for internal resources (e.g., nodes on the logical network). Internal DNS 302 may allow users of the nodes to access internal services, such as intranet sites, file servers, and databases, using easily memorable domain names rather than numerical IP addresses. By managing its own DNS records, an entity operating the logical network can maintain control over its internal network structure, enhance security, and customize the resolution process according to its specific requirements, such as using proxy node 303 for the domain name of this example. Association of the domain name with proxy node 303 in internal DNS 302 directs internal DNS 302 to forward DNS requests indicating the domain name to proxy node 303 rather than internal DNS 302 resolving the request itself.

In this example, node 301A of nodes 301 is requesting a connection to the application provided by application server 311. To establish the connection, node 301A transmits a DNS request with the domain name of the application to internal DNS 302 over the logical network in internal domain 341 (step 403). Internal DNS 302 recognizes that the DNS request includes the domain name associated with proxy node 303 and forwards the DNS request to proxy node 303 (step 405). In other examples, internal DNS 302 may instruct node 301A to resend the request to proxy node 303 rather than internal DNS 302 forwarding the request to proxy node 303. Proxy node 303 then resolves the DNS request (step 406). Proxy node 303 may transmit a DNS request with the domain name to an external DNS server(s) outside of internal domain 341 to retrieve a route for connections to the application. For example, the external DNS server may be a nameserver for domain names on the wider Internet, which includes external domain 351. In response to the DNS request from proxy node 303, proxy node 303 is provided with an IP address of application server 311 and a route to external domain 351 in which the IP address is located.

Proxy node 303 provides a DNS response to node 301A (step 407). In other examples, proxy node 303 may provide the response to internal DNS 302, which then forwards the response to node 301A. The DNS response at least indicates the IP address of application server 311 to which node 301A can establish a connection to access the application. To connect with application server 311, node 301A requires a route to the IP address of application server 311. In anticipation of that fact, proxy node 303 broadcasts the route to external domain 351 that proxy node 303 determined during the DNS resolution (step 408). In this example, the broadcast advertises the route to external domain 351 to every node in internal domain 341, including node 301A. Upon receiving the broadcasted route, node 301A knows that proxy node 303 can route packets to external domain 351 where application server 311 is located. Thus, nodes 301 sends outbound traffic addressed with the IP address of application server 311 to proxy node 303 (step 409). Application server 311, likewise, transmits inbound traffic back to node 301A via a route through proxy node 303 (step 410). In some examples, proxy node 303 may advertise to external domains that proxy node 303 is a route for communications directed to nodes within internal domain 341 from external domain 351.

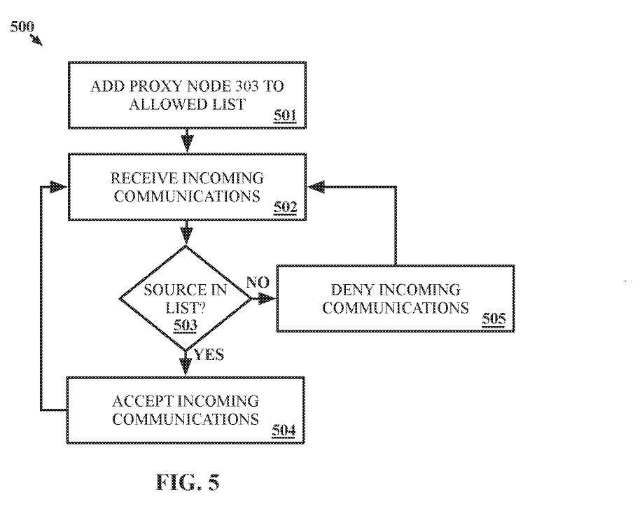

FIG. 5 illustrates operation 500 to control access to external applications from within a private network. Operation 500 is an example where the application provided by application server 311 is directed to allow access from certain systems/devices. The system/device may explicitly identify itself to application server 311 (e.g., by providing credentials, such as a password or security token) or may be implied based on an identifier in communications from the system/device (e.g., a source IP address in packets received by application server 311). The system/device that is proxy node 303 is what application server 311 is configured to allow in the example of operation 500.

Specifically, proxy node 303 is added to a list of allowed systems to access the application (step 501). Control plane 109 may provide necessary identifying information to application server 311 (and other application servers for the application in external domain 351, as may be the case in other examples) or proxy node 303 may itself provide the identifying information after being notified that it is to be a proxy node (e.g., proxy node 303 may log into the application). When application server 311 receives incoming communications (step 502), application server 311 checks the allowed list to determine whether the incoming communications are received from an allowed system (step 503). If the communications are not from a system in the allowed list, application server 311 denies the incoming communications (step 505). Application server 311 may simply discard the incoming communications or may respond to the incoming communications with a message notifying the sender that the communications are not allowed.

If, however, the communications are received from proxy node 303 (or any other system on the allowed list, application server 311 accepts the communications (step 504). Since proxy node 303 is allowed on behalf of all systems in internal domain 341, the communications may have actually originated from any node within internal domain 341. But, since the communications appear to have originate from proxy node 303, application server 311 allows the communication. For example, encapsulated packets with communications for application server 311 may be transmitted from node 301A to proxy node 303. Proxy node 303 removes the encapsulation and transmits the previously encapsulated packets to application server 311 with proxy node 303 being the source of those previously encapsulated packets. Thus, the packets appear to application server 311 as though they are from a system on the allowed list. All nodes within internal domain 341 can, therefore, take advantage of proxy node 303 being on the allowed list even though they are not explicitly on the allowed list.

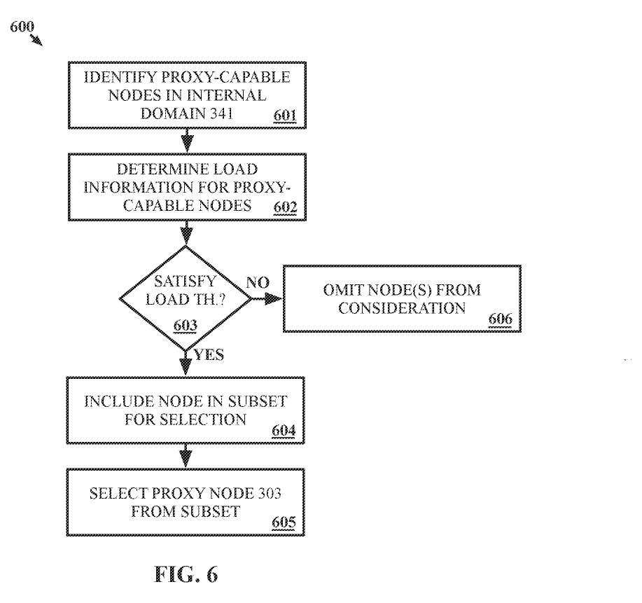

FIG. 6 illustrates operation 600 to control access to external applications from within a private network. Operation 600 is an example of logic that control plane 309 may use to select a proxy node when a new proxy node is desired for an application. In operation 600, control plane 309 identifies proxy-capable nodes in internal domain 341 (step 601). Proxy-capable nodes may be nodes that have hardware configurations conducive to operating as a proxy, nodes that are not battery powered (e.g., laptops, tablets, etc.), are nodes that have enough (e.g., a threshold amount) spare bandwidth or processing resources, or any other type of capable node. For instance, an operator of the logical network having internal domain 341 may include servers as nodes in internal domain 341. The servers may be dedicated to acting as proxies or may be used for other purposes as well. Those servers may be preferable over user systems (e.g., personal computers, laptops, smartphones, or other type of user device) that may lack processing resources, network reliability, intermittent uptime, etc. Control plane 309 may identify which type of node the nodes in internal domain 341 are, a user may indicate the node types to control plane 309, or control plane 309 may use some other mechanism for determining device type for a node.

Control plane 309 further determines load information for the proxy-capable nodes (step 602). The load information may include processing resources used/available, memory used/available, network bandwidth used/available, or any other type of performance information that may indicate the ability of a node to act as a proxy for another application. Control plane 309 may query the proxy-capable nodes for the load information, the nodes may provide the information to control plane 309 automatically (e.g., periodically or on some other schedule), or control plane 309 may obtain the load information from some other source. Control plane 309 determines whether the load information for respective nodes satisfies one or more load thresholds (step 603). Each load threshold may indicate a resource usage amount above which a node is not able to handle additional proxy duties or a resource availability amount below which a node is not able to handle additional proxy duties. For example, a threshold amount of available bandwidth may be needed to accept proxy duties. If a node does not meet that threshold, the node is omitted from consideration for selection as a proxy (step 606). The thresholds may differ depending on an amount of resources control plane 309 expects an application to use. The expected amount of resources may be indicated by a user, may be estimated based on historical application used, or may be determined using some other logic. For instance, if a large portion of the nodes in internal domain 341 are anticipated to use the application, then the threshold may be set to account for the amount of anticipated usage.

Nodes that are not omitted, are those that have enough available resources to handle the proxy duties of the application and are included in a subset of proxy-capable nodes (step 604). A proxy node, proxy node 303 in this case, is selected by control plane 309 from the subset (step 605). Proxy node 303 may be a random selection from the subset, control plane 309 may select proxy node 303 based on the load information (e.g., proxy node 303 may have the greatest amount of resources available), or control plane 309 may use some other selection logic to select proxy node 303.

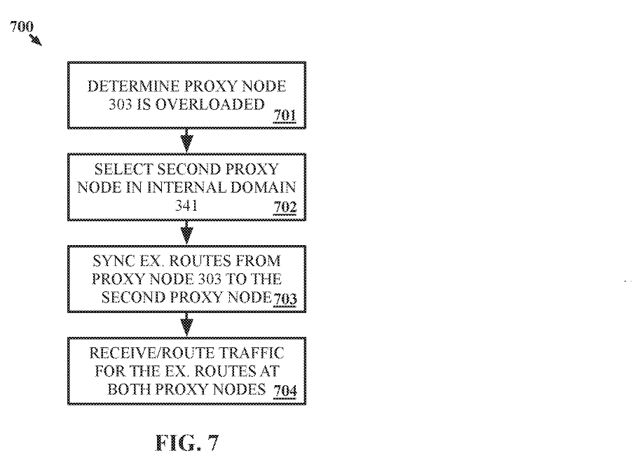

FIG. 7 illustrates operation 700 to control access to external applications from within a private network. Operation 700 is an example for load balancing between multiple proxy nodes. If internal domain 341 is large enough, there may be many nodes using an application. Especially as more nodes begin using an application, the ability of a single proxy node to handle all the communications between the nodes in internal domain 341 and the application in external domain 351 may be greatly reduced. Thus, control plane 309 may load balance the proxy duties among multiple nodes.

In operation 700, control plane 309 determines proxy node 303 is overloaded (step 701). Control plane 309 may continue to gather load information like it did in operation 600 and compare that load information to thresholds indicating capacity is approaching a point where an additional proxy node is needed to ensure the application can be provided to internal domain 341 without adverse effects. Once control plane 309 determines another proxy node is needed, control plane 309 selects a second proxy node (step 702). Control plane 309 may perform operation 600 to select the second proxy node. In some examples, control plane 309 may consider geographic location of a node when selecting a proxy node. Selecting closer nodes geographically to nodes communicating with the proxy nodes may reduce latency in the communications being exchanged therewith.

Once a second proxy node is selected, control plane 309 synchronizes the external routes being advertised by proxy node 303 with the second proxy node (step 703). The second proxy node then begins advertising those routes just like proxy node 303. With two nodes advertising the routes, a node needing the routes to send traffic to an application using the routes can select either proxy node to receive the traffic. Thus, should the second proxy node receive the traffic, the second proxy node routes the traffic to the external domain just like proxy node 303 would (step 704). Even further proxy nodes may be added should the capacity be needed. Also, in examples where the application uses an allowed list, the second proxy node may be added to the allowed list like proxy node 303 was in operation 500.

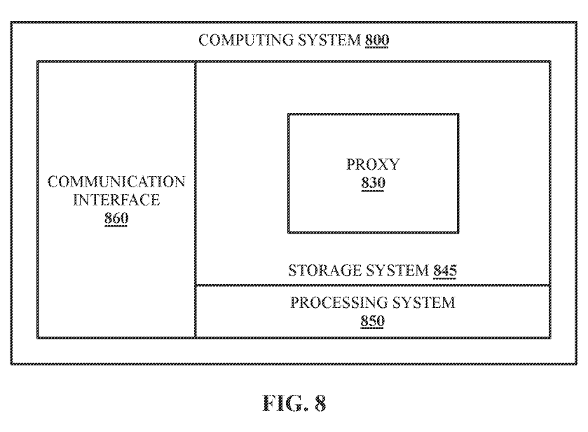

FIG. 8 illustrates computing system 800 for a computing system for controlling access to external applications from within a private network. Computing system 800 is representative of any computing system or systems with which the various operational architectures, processes, scenarios, and sequences disclosed herein can be implemented. Computing system 800 is an example architecture for nodes 101-108, control plane 109, application 111, nodes 301, control plane 309, internal DNS 302, proxy node 303, and application servers 311-312, although other examples may exist. Computing system 800 includes storage system 845, processing system 850, and communication interface 860. Processing system 850 is operatively linked to communication interface 860 and storage system 845. Communication interface 860 may be communicatively linked to storage system 845 in some implementations. Computing system 800 may further include other components such as a battery and enclosure that are not shown for clarity.

Communication interface 860 comprises components that communicate over communication links, such as network cards, ports, radio frequency (RF), processing circuitry and software, or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format — including combinations thereof. Communication interface 860 may be configured to communicate with one or more web servers and other computing systems via one or more networks.

Processing system 850 comprises microprocessor and other circuitry that retrieves and executes operating software from storage system 845. Storage system 845 may include volatile and nonvolatile, removable, and non-removable media implemented in any method or technology for storage of information, such as computer readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 845, or any other computer-readable storage medium herein, be considered a transitory form of signal transmission (often referred to as "signals per se"), such as a propagating electrical or electromagnetic signal or carrier wave.

Processing system 850 is typically mounted on a circuit board that may also hold the storage system. The operating software of storage system 845 comprises computer programs, firmware, or some other form of machine-readable program instructions. The operating software of storage system 845 comprises proxy module 830. The operating software on storage system 845 may further include an operating system, utilities, drivers, network interfaces, applications, or some other type of software. When read and executed by processing system 850, the operating software on storage system 845 directs computing system 800 to control access to external applications from within a private network.

In at least one example, proxy module 830 directs processing system 850 to receive, from a control plane of a private network, an indication of an external domain in which an application is located. The external domain is external to an internal domain for the private network and the control plane selects the node to be a proxy in the internal domain for communications exchanged with the application. Proxy module 830 also directs processing system 850 to advertise, to the nodes in the private network, an external-domain route to the external domain and route traffic exchanged between the nodes in the private network and the application in accordance with the external-domain route.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for controlling access to external applications from within a private network, the method comprising:
determining an external domain in which an application is located, wherein the external domain is external to an internal domain for the private network;
selecting a proxy node in the internal domain to be a proxy for communications exchanged with the application;
advertising, from the proxy node to nodes in the private network, an external-domain route to the external domain; and
routing traffic exchanged between the private network and the application via the external-domain route through the proxy node.

2. The method of claim 1, comprising:
directing the application include the proxy node in a list of systems with which the application is allowed to communicate.

3. The method of claim 1, comprising:
at the proxy node:
receiving a Domain Name System (DNS) request indicating the external domain from a requesting node in the internal domain;
resolving the DNS request to determine the external-domain route in response to the DNS request; and
transmitting, to the requesting node, a response to the DNS request.

4. The method of claim 3, wherein selecting the proxy node comprises:
instructing an internal DNS server for the private network to direct DNS requests indicating the external domain to the proxy node.

5. The method of claim 3, comprising:
at the proxy node:
receiving a subsequent DNS request indicating the external domain;
resolving the subsequent DNS request to determine a second external-domain route in response to the subsequent DNS request; and
advertising, from the proxy node to the nodes in the private network, the second external-domain route.

6. The method of claim 1, wherein selecting the proxy node comprises:
selecting the proxy node from a plurality of nodes in the internal domain that are able to operate as the proxy.

7. The method of claim 6, wherein a node is able to operate as the proxy when the node comprises a system of a specified type.

8. The method of claim 1, wherein selecting the proxy node comprises:
determining load information for a plurality of nodes in the internal domain that are able to be the proxy;
selecting a subset of the plurality of nodes based on the load information, wherein the load information indicates loads of the subset are below a threshold load; and
selecting the proxy node from the subset.

9. The method of claim 1, wherein selecting the proxy node comprises:
selecting a second proxy node in the internal domain to be a second proxy for the communications exchanged with the application;
synchronizing the external-domain route between the proxy node and the second proxy node; and
routing second traffic exchanged between the private network and the application via the external-domain route through the second proxy node.

10. The method of claim 1, comprising:
receiving user input from an administrator of the private network, wherein the user input includes the external-domain route;
determining the proxy node is advertising one or more routes that are sub-routes of the external-domain route; and
ending advertisement of the one or more routes.

11. An apparatus implementing a node of a private network to control access to external applications by nodes in the private network, the apparatus comprising:
one or more computer readable storage media;
one or more processing systems operatively coupled with the one or more computer readable storage media; and
program instructions stored on the one or more computer readable storage media that, when read and executed by the processing system, direct the apparatus to:
receive, from a control plane of the private network, an indication of an external domain in which an application is located, wherein the external domain is external to an internal domain for the private network, wherein the control plane selects the node to be a proxy in the internal domain for communications exchanged with the application;
advertise, to the nodes in the private network, an external-domain route to the external domain; and
route traffic exchanged between the nodes in the private network and the application in accordance with the external-domain route.

12. The apparatus of claim 11, wherein the application includes the node in a list of systems with which the application is allowed to communicate.

13. The apparatus of claim 11, wherein the program instructions direct the apparatus to:
receive a Domain Name System (DNS) request indicating the external domain from a requesting node in the internal domain;
resolve the DNS request to determine the external-domain route in response to the DNS request; and
transmit, to the requesting node, a response to the DNS request.

14. The apparatus of claim 13, wherein the control plane instructs an internal DNS server for the private network to direct DNS requests indicating the external domain to the proxy node.

15. The apparatus of claim 13, wherein the program instructions direct the apparatus to:
receive a subsequent DNS request indicating the external domain;
resolve the subsequent DNS request to determine a second external-domain route in response to the subsequent DNS request; and
advertise, from the node to the nodes in the private network, the second external-domain route.

16. The apparatus of claim 11, wherein the node comprises a computing system of a specified type and is selected by the control plane from a plurality of nodes of the specified type.

17. The apparatus of claim 11, wherein user input from an administrator of the private network indicates the external-domain route and wherein the program instructions direct the apparatus to:
determine the node is advertising one or more routes that are sub-routes of the external-domain route; and
end advertisement of the one or more routes.

18. A system forming a private network to control access to external applications by nodes in the private network, the system comprising:
a control plane of the private network configured to:
determine an external domain in which an application is located, wherein the external domain is external to an internal domain for the private network; and
select a proxy node in the internal domain to be a proxy for communications exchanged with the application; and
the proxy node configured to:
advertise within the internal domain an external-domain route to the external domain;
receive, from other nodes in the internal domain, traffic directed to the external domain; and
send the traffic to the external-domain route.

19. The system of claim 18, comprising:
the other nodes configured to:
receive the external-domain route from the proxy node;
identify the traffic; and
transmit the traffic to the proxy node in accordance with the external-domain route.

20. The system of claim 18, comprising:
the control plane configured to direct the other nodes to send Domain Name System (DNS) requests for the external domain to the proxy node; and
the other nodes configured to send the DNS requests to the proxy node and receive the external-domain route in response to the DNS requests.
